(19) United States
(12) Patent Application Publication
(10) Pub. No.: US 2026/0290168 A1
(43) Pub. Date: Sep. 24, 2026

(54) AUTOMATED PARKING MANAGEMENT SYSTEM

(71) Applicant: Inflow Inc., Milwaukee, WI (US)

(72) Inventors: Scott Vanderbeck, Jacksonville, FL (US); Anthony Janowiec, Lac Du Flambeau, WI (US); Erica Vaillancourt, Muskego, WI (US)

(21) Appl. No.: 19/570,338

(22) Filed: Mar. 18, 2026

Related U.S. Application Data
(60) Provisional application No. 63/775,710, filed on Mar. 21, 2025.

(51) Int. Cl. G08G 1/14; G06V 20/52; G06V 20/62; G07B 15/04

(52) U.S. Cl. CPC G08G 1/149; G06V 20/52; G06V 20/625; G07B 15/04; G06V 2201/08

(57) ABSTRACT

A method includes obtaining first image data of a vehicle at a first barrier located at an entrance of a parking facility and withdrawing the first barrier to grant the vehicle passage. The method includes obtaining a first vehicle identifier identifying the vehicle and receiving, from a user device, a parking request requesting a parking session for the vehicle at the parking facility. The method includes determining that the first vehicle identifier matches a second vehicle identifier. Based on the determination, the method includes generating the parking session. The method includes obtaining a third vehicle identifier identifying the vehicle at a second barrier located at an exit of the parking facility and determining that the third vehicle identifier matches the first vehicle identifier and the second vehicle identifier. Based on this determination, the method includes withdrawing the second barrier to grant the vehicle passage to exit the parking facility.

### CROSS REFERENCE TO RELATED APPLICATION

The present application claims the filing benefits of U.S. provisional application Ser. No. 63/775,710, filed Mar. 21, 2025, which is hereby incorporated herein by reference in its entirety.

### TECHNICAL FIELD

This disclosure relates to automated parking management systems.

### BACKGROUND

Conventional parking management systems control parking sessions by providing a user a parking ticket. The user generally receives the parking ticket upon entry to the parking facility, via, for example, a ticket kiosk at a gate barring entry to the parking facility. The user then presents the parking ticket along with payment when exiting the parking lot.

### SUMMARY

A computer-implemented method, when executed by data processing hardware, causes the data processing hardware to perform operations. The operations include obtaining first image data of a vehicle at a first barrier located at an entrance of a parking facility. The first image data is captured via a first image sensor mounted at the entrance of the parking facility. The operations also include, after obtaining the first image data, withdrawing the first barrier to grant the vehicle passage to enter to the parking facility. The operations include obtaining a first vehicle identifier identifying the vehicle. The first vehicle identifier is derived from the first image data. The operations also include receiving, from a user device, a parking request requesting a parking session for the vehicle at the parking facility. The parking request includes a second vehicle identifier identifying the vehicle and one or more parking parameters. The operations include determining that the first vehicle identifier matches the second vehicle identifier. Based on determining that the vehicle identified by the first vehicle identifier and the vehicle identified by the second vehicle identifier match, the operations include generating the parking session for the vehicle based on the one or more parking parameters. The operations also include obtaining a third vehicle identifier identifying the vehicle at a second barrier located at an exit of the parking facility. The third vehicle identifier derived from second image data captured via a second image sensor mounted at the exit of the parking facility. The operations include determining that the third vehicle identifier matches the first vehicle identifier and the second vehicle identifier. Based on determining that the third vehicle identifier matches the first vehicle identifier and the second vehicle identifier, the operations include withdrawing the second barrier to grant the vehicle passage to exit the parking facility and completing the parking session.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1A is a schematic view of an example system for an automated parking management system.

FIG. 1B is a schematic view of another example system for an automated parking management system.

FIG. 2 is a schematic view of exemplary components of the automated parking management systems of FIGS. 1A and 1B.

FIG. 3 is a schematic view of example kiosks of an automated parking management system.

FIG. 4 a flowchart of an example arrangement of operations for a method for an automated parking management system.

FIG. 5 is a schematic view of an example computing device that may be used to implement the systems and methods described herein.

Like reference symbols in the various drawings indicate like elements.

### DETAILED DESCRIPTION

Conventional parking management systems track the duration of parking sessions using ticket-based entry and exit. For example, a kiosk at a gated entry of a parking facility may dispense a time-stamped ticket before receiving access to the parking facility. Another kiosk at a gated exit of the parking facility may include a scanning system or a live attendant to scan the ticket and receive payment. Thus, it is common for a user of a parking facility to stop at an entrance gate, receive a parking ticket, and pay the parking ticket via an attendant or kiosk. Requiring the user to pay for the parking session upon exit creates ergonomic difficulty, such as requiring the user to lean out through a window of the vehicle to provide a payment method at the kiosk. The payment process further increases the time during which the vehicle sits at the exit of the parking facility, potentially delaying other users from exiting the facility. Thus, conventional techniques inconvenience the user and restrict traffic flow to and from the parking facility.

Implementations herein include a parking facility that includes an automated, ticketless parking management method and system. Contactless payment reduces entry and exit time and reduces the need for live attendants. The system implements one or more image sensors to capture vehicle identifiers as vehicles approach a barrier at the entrance of the parking facility. Users, once parked, confirm the vehicle identifiers to generate parking sessions. The parking management system automatically processes and completes parking sessions when users approach a barrier at the exit of the parking facility. One or more image sensors mounted at the exit obtain further vehicle identifiers. The system grants vehicles passage to exit the parking facility upon determining that the vehicle identifiers collected at the entrance and confirmed by the users match the vehicle identifiers obtained at the exit. Thus, the parking management system enables users to park without the impediments of collecting a parking ticket, dispensing payment at a kiosk, and/or relying on a parking attendant.

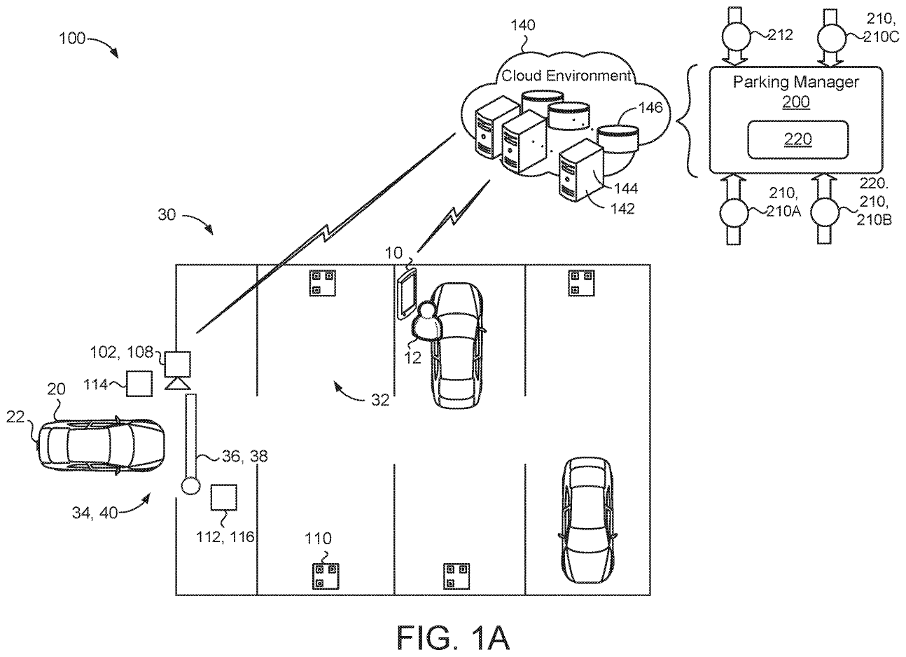

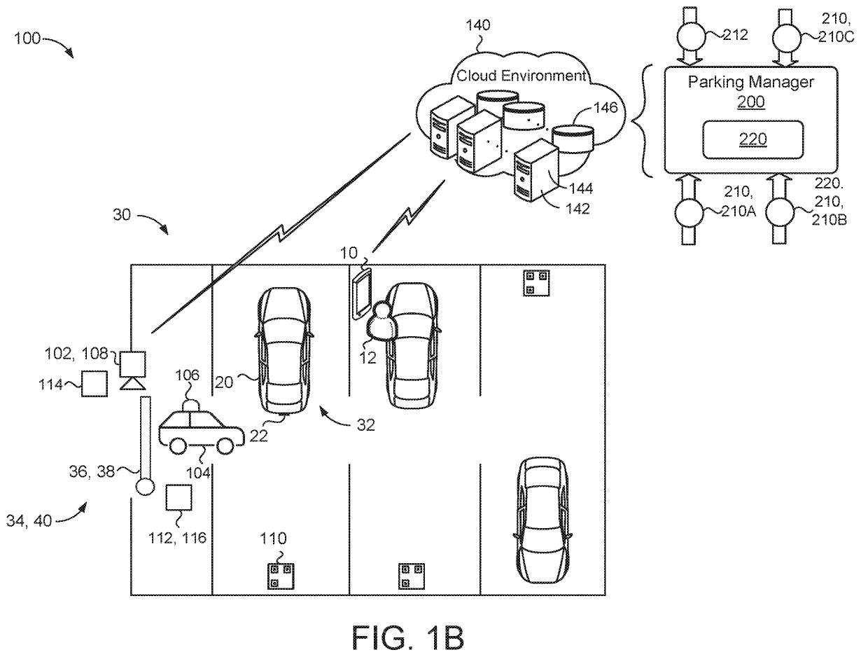

Referring to FIGS. 1A and 1B, in some implementations, an example parking management system 100 includes a remote system 140 in communication with one or more user devices 10. The remote system 140 may be a single computer, multiple computers, or a distributed system (e.g., a cloud environment) having scalable/elastic resources 142 including computing resources 144 (e.g., data processing hardware) and/or storage resources 146 (e.g., memory hardware). The user device 10 may correspond to any computing device, such as a laptop, a mobile device (i.e., a smart phone), a smart watch, a tablet, etc.

In some implementations, image data of the vehicle 20 is obtained at a barrier 36 located at an entrance 34 of the parking facility 30 by an image sensor 102 (e.g., a camera). The image sensor 102 may be mounted at or near the entrance 34 of the parking facility 30 such that the image sensor 102 has a field of view that includes at least a portion of the entrance 34 of the parking facility 30. Vehicles 20 that approach the barrier 36 at the entrance 34 enter the field of view of the image sensor 102 and the image sensor 102 captures image data representative of the vehicle 20. Upon obtaining the image data, the parking management system 100 may withdraw the barrier 36 to grant the vehicle 20 passage to enter the parking facility 30.

In some examples, the remote system 140 executes a parking manager 200. The parking manager 200 receives a first vehicle identifier 210, 210A identifying the vehicle 20 entering a parking facility 30. The first vehicle identifier 210A is derived from the image data captured by the image sensor 102. The image sensor 102, the parking manager 200, and/or a third-party server extracts, from the image data, the first vehicle identifier 210A (e.g., via machine vision or a license plate recognition system). For example, the first vehicle identifier 210A includes a license plate number/value 22 that uniquely identifies the vehicle. As used herein, a license plate number refers to any alphanumeric identifier that uniquely identifies a vehicle (such as the identifier found on a vehicle registration plate, number plate, license plate, etc.). The image sensor 102 may capture image data representative of a front of the vehicle and/or the rear of the vehicle (e.g., to capture a license plate number at the front and/or the rear of the vehicle). Other vehicle identifiers 210 may include vehicle make, model, color, design, etc. That is, the vehicle identifier 210 may include a license plate number or any other visual feature of the vehicle discernable by the image sensor 102. Optionally, the parking manager 200 may determine a timestamp representing when the vehicle 20 entered the parking facility 30 or when the image data was captured. The timestamp may be recorded by the image sensor 102, the parking manager 200, and/or the third-party server.

In some instances, the image sensor 102, the parking manager 200, or the third-party server may fail to derive and/or extract the first vehicle identifier 210A from the image data captured by the image sensor 102. For example, an object, a person, another vehicle, dirt (or other physical occlusions), and/or glare may obscure the vehicle 20 from view of the image sensor 102 such that the vehicle identifier 210 cannot be derived from the image data. For example, a bicycle mounted to the vehicle may obscure the license plate from view by the image sensor 102.

In some implementations of the parking management system 100, an entrance kiosk 114 may be located at the barrier 34. Upon determining that the first vehicle identifier 210A cannot be derived from the image data, the parking manager 200 may, via a monitor, speaker, or other means at the entrance kiosk 114, prompt the user 12 or a driver of the vehicle for information to initiate a parking session 250. In one example, the entrance kiosk 114 may request that the user 12 provide a phone number associated with the user device 10 before granting entry to the parking facility 30. The user 12 may provide the phone number by reciting the phone number into a microphone at the entrance kiosk 114 or entering the phone number at the monitor of the entrance kiosk 114. Alternatively, the user 12 may submit the phone number via text message to a parking facility phone number provided at the entrance kiosk 114, or via scanning a quick response (QR) code 110 provided at the entrance 34. For example, scanning the QR code 110 prompts the user device 10 to execute a standalone application or directs a web browser to a specific URL, at which the user 12 may provide the phone number to the parking manager 200. The phone number may later be used as a means to identify the parking session 250 associated with the vehicle 20. Upon receiving the phone number, the parking management system 100 may withdraw the barrier 36 to grant the vehicle 20 passage to enter the parking facility 30.

In some implementations of the parking management system 100, a parking facility monitor 104 may monitor and/or patrol the parking facility 30 and capture image data of vehicles, such as vehicle 20, parked in the parking spaces. For example, the parking facility monitor 104 may be a vehicle, an autonomous vehicle, an autonomous robot, a person, etc. The parking facility monitor 104 may be equipped with an image sensor 106 (e.g., a camera) to capture image data representative of the vehicles 20. The image sensor 106 of the parking facility monitor 104, the parking manager 200, and/or a third-party server may extract, from the image data captured by the image sensor 106, the first vehicle identifier 210A. Thus, in some examples, the parking facility monitor 104 is mobile. In these examples, the monitor(s) 104 may periodically or continuously patrol the parking facility 30 to determine vehicle identifiers 210 as quickly as possible.

In other examples, the monitors 104 are fixed or static. For example, the monitors 104 include any number of cameras or other image sensors mounted to infrastructure of the parking facility 30. The cameras may have a fixed point of view or may rotate or swivel to capture a larger field of view. In these examples, the monitors 104 may be distributed such that most or all parking spaces are within the field of view of one or more monitors 104.

The parking manager 200 may receive the first vehicle identifier 210A from the image data captured by the image sensor 106. For example, the first vehicle identifier 210A includes the license plate number 22 of the vehicle 20. Additionally or alternatively, the first vehicle identifier 210A may include vehicle make, model, color, design, etc., of the vehicle 20. Optionally, the parking manager 200 may determine a timestamp of when the vehicle 20 entered the parking facility 30 or when the image data was captured. The timestamp may be recorded by the image sensor 102, the parking manager 200, and/or the third-party server.

After the vehicle 20 enters the parking facility 30, the vehicle 20 maneuvers to an available parking space 32 and parks. After parking, in some examples (e.g., when the user 12 and/or driver of the vehicle 20 is a transient parker and not a permit parker or subscription parker), the user 12 of the vehicle 20 transmits, to the parking manager 200, via a user device 10, a parking request 220 requesting parking access for the vehicle 20 at the parking facility 30. The parking request 220 includes a second vehicle identifier 210, 210B identifying the vehicle 20. For example, the user 12 provides the license plate number 22 to the parking manager 200. Additionally or alternatively, the user 12 may provide vehicle make, model, color, design, etc., of the vehicle 20. The user 12 may refer to the driver or an occupant of the vehicle. In some examples, upon receiving the phone number from the user 12 at the entrance kiosk 114, the parking manager 200 may send a text message (e.g., SMS message or iMessage) including a URL to the user device 10. At the web address of the URL, the user 12 may submit the parking request 220.

Optionally, the parking request 220 may include a preferred payment method selected by the user 12. For example, the user 12, via the user device 10, may determine to pay for parking with a credit card or legal tender (i.e., a cash payment). If the user 12 determines to pay for parking with a credit card, the parking manager 200 may request credit card information from the user 12 (e.g., credit card number, name on the credit card, expiration date, security code, etc.). In some examples, the user 12 may prepay for a duration of parking via the parking request 220. For example, the user 12 may prepay for one or more hours of parking, or one or more days of parking. Accordingly, the parking manager 200 may provide a confirmation code to the user device 10. Upon arriving at the exit 38, the user 12 may input the confirmation code at the kiosk 112 to end the parking session 250 and exit the parking facility 30.

Optionally, the user 12 generates/transmits the parking request 220 via an application executing on the user device 10. For example, the user device 10 executes a standalone parking application or a web browser that allows the user 12 to enter (e.g., via a keyboard, voice, etc.) the second vehicle identifier 210B. In some examples, the user 12 scans a QR code 110 with the user device 10. The QR code 110 directs the user device 10 to execute the proper application. For example, scanning the QR code 110 prompts the user device 10 to execute a standalone application or directs a web browser to a specific URL. The QR code 110 may include one or more parameters that are provided to the parking manager 200 via the parking request 220. For example, the QR code 110 includes a location of the parking facility 30 and/or a specific parking location 32 within the parking facility 30. The QR code 110 may be specific to the parking location 32 that the vehicle 20 parks in (e.g., displayed at or within the parking location 32. Alternatively, the QR code 110 is generic to the parking facility 30 and displayed at various locations (e.g., at signage) around the parking facility 30.

The image sensor 102 and/or the user device 10 may communicate with the parking manager 200 in any number of ways. For example, the communications may include wireless or wired communications directly to the parking manager 200 (e.g., when the remote system 140 is located on-premises at or near the parking facility 30) or via one or more intermediaries (e.g., servers). The image sensor 102 may communicate with the parking manager 200 via an application programming interface (API) conforming to representational state transfer (REST) constraints. In some examples, the remote system executes in “the cloud” and the image sensor 102 and/or the user device 10 communicate with the parking manager 200 via the Internet. The user device 10 may communicate with the parking manager 200 via cellular communication technologies or via any other wireless communication protocols (e.g., WIFI or BLUETOOTH).

The parking manager 200, after receiving both the first vehicle identifier 210A and the second vehicle identifier 210B, determines that the first vehicle identifier 210A matches or is the same as the second vehicle identifier 210B. That is, the parking manager 200 matches the first vehicle identifier 210A to the second vehicle identifier 210B (e.g., based on a similarity between the first vehicle identifier 210A and the second vehicle identifier 210B). Alternatively, the parking manager 200 determines whether the vehicle 20 associated with the first vehicle identifier 210A matches the vehicle 20 associated with the second vehicle identifier 210B (i.e., the vehicle identifiers 210 need not match in some scenarios). In response, the parking manager 200 generates a parking session 250 for the vehicle 20. The parking session 250 is uniquely associated with the vehicle 20 which is uniquely associated with the first vehicle identifier 210A and the second vehicle identifier 210B. Optionally, the parking manager 200 may associate the phone number of the user device 10 with the parking session 250, such that the phone number may later be used as a means to identify the parking session 250.In some instances, the parking manager 200 may determine that the vehicle identified by the second vehicle identifier 210B fails to match or is not the same as the vehicle identified by the first vehicle identifier 210A. That is, the first vehicle identifier 210A and the second vehicle identifier 210B may not match. For example, faulty image data captured by the image sensor 102, 106 and/or faulty derivation of the first vehicle identifier 210A from the image data may result in the parking manager 200 receiving an inaccurate first vehicle identifier 210A. Alternatively, the parking manager 200 may receive an inaccurate second vehicle identifier 210B from the user device 10. When determining if identifiers 210 match, the parking manager 200 may determine if the second vehicle identifier 210B matches any identifier 210A derived from image data captured by the sensor 102. Alternatively, the parking manager determines if a first vehicle identifier 210A matches any vehicle identifier 210B received from a user device 10.

Based on determining that matching vehicle identifiers 210 cannot be found (i.e., the vehicle identifier 210B provided by the user does not match any vehicle identifier 210 captured by the sensor(s) 102), the parking manager 200 may request identifying features 212 of the vehicle 20 from the user 12. In one example, the identifying features 212 includes a resubmission of the license plate number 22 of the vehicle 20 by the user 12. In another example, the identifying features 212 may include a make, model, color, design, etc., of the vehicle 20. The parking manager 200 may compare the identifying features 212 to visual features derived from the captured image data to determine a match. For example, when the parking manager 200 fails to obtain a license plate match, the user may indicate that their vehicle is a red Ford Bronco. In this example, the parking manager 200 may determine if a vehicle matching these identifying features 212 was captured by the sensors 102. The parking manager 200 may determine the visual features simultaneously with determining the first vehicle identifier 210A. Alternatively, the parking manager 200 may only determine the visual features when the first vehicle identifier 210A cannot be derived from the sensor data. In yet another example, the parking manager 200 may determine the visual features upon determining the lack of a match with the second vehicle identifier 210B.

Additionally or alternatively, the parking manager 200 may request, based on determining that matching vehicle identifiers 210 cannot be found, that the user 12 provide the phone number associated with the user device 10. Based on receiving the phone number from the user device 10, the parking manager 200 may determine the parking session 250 associated with the phone number. If a plurality of parking sessions 250 are associated with the phone number, the parking manager 200 may communicate to the user device 10 the plurality of parking sessions 250 and request the user 12 to select the parking session 250 associated with the time at which the vehicle 20 entered the parking facility 30. In some examples, the plurality of parking sessions 250 associated with the vehicle 20 and/or phone number may have payments pending. Accordingly, the parking manager 200 may request the user 12 to select the parking session 250 for which the user 12 would like to submit payment.

In another example, the parking manager 200 may present to the user 12, via the user device 10, vehicle identifiers 210 of vehicles 20 that previously entered the parking facility 30 but are not yet associated with a parking session 250. The user 12 may then select the vehicle 20 from the vehicle identifiers presented to the user 12.

The parking manager 200 receives the identifying features 212 from the user. After receiving the identifying features 212, the parking manager 200 may determine that the vehicle identified by the first vehicle identifier 210A matches the identifying features 212. That is, the parking manager 200 matches the first vehicle identifier 210A to the identifying features 212 (e.g., based on a similarity between the first vehicle identifier 210A and the identifying features 212). Alternatively, the parking manager 200 determines whether the vehicle 20 associated with the first vehicle identifier 210A matches the vehicle 20 associated with the identifying features 212 (i.e., the vehicle identifier 210A and the identifying features 212 need not match in some scenarios). In response to a match (e.g., a threshold amount of similarity), the parking manager 200 generates a parking session 250 for the vehicle 20.

The parking session 250 is uniquely associated with the vehicle 20 which is uniquely associated with the first vehicle identifier 210A and the identifying features 212. In such instances where the parking manager 200 generates the parking session 250 associated in part with identifying features 212, the parking manager 200 processes the identifying features 212 in the same manner that it would for a second vehicle identifier 210B. In some examples, if the parking manager 200 determines, based on the first vehicle identifier 210A and the identifying information 212, that the first vehicle identifier 210A is inaccurate, the parking manager 200 may process the associated parking session 250 using solely the identifying features 212. In other words, the parking manager 200 may disregard the first vehicle identifier 210A when the vehicle 20 associated with the identifying information 212 is matched to a vehicle 20 at the exit 40 of the parking facility 30.

The parking manager 200, after generating the parking session 250, receives a third vehicle identifier 210, 210C identifying the vehicle 20 as the vehicle 20 approaches and/or arrives at the exit 40 of the parking facility 30. The exit 40 may be the same as the entrance 34 or different. In some examples, image data of the vehicle 20 is obtained at a barrier 38 located at an exit 40 of the parking facility 30 by an image sensor 108 (e.g., a camera). The barrier 38 may be the same barrier 36 that barred entry to the parking facility 30 or a different barrier. The image sensor 108 may be mounted at or near the exit 40 of the parking facility 30 such that the image sensor 108 has a field of viewing that includes at least a portion of the exit 40 of the parking facility. The third vehicle identifier 210C may be derived from image data captured by the image sensor 108. For example, the third vehicle identifier 210C includes the license plate number 22 of the vehicle 20. Additionally or alternatively, the third vehicle identifier 210C may include the make, model, color, design, etc., of the vehicle 20. In some examples, the image sensor 102 is the same as the second image sensor 108 (e.g., when the entrance 34 and the exit 40 of the parking facility 30 are co-located). In other examples, the image sensor 102 and the image sensor 108 are separate devices.

The parking manager 200, in response to receiving the third vehicle identifier 210C, determines that the vehicle 20 identified by the third vehicle identifier 210C matches or is the same as the vehicle 20 identified by the first vehicle identifier 210A and the vehicle 20 identified by the second vehicle identifier 210B. That is, the parking manager 200 matches the third vehicle identifier 210C to the first vehicle identifier 210A and the second vehicle identifier 210B (e.g., based on similarity among the first vehicle identifier 210A, the second vehicle identifier 210B, and the third vehicle identifier 210C). Alternatively, the parking manager determines whether the vehicle 20 associated with the third vehicle identifier 210C is the same as the vehicle 20 identified by the first vehicle identifier 210A and the vehicle 20 identified by the second vehicle identifier 210B (i.e., the vehicle identifiers 210 need not match in some scenarios). Based on determining that the vehicle 20 identified by the third vehicle identifier 210C matches or is the same as the vehicle 20 identified by the first vehicle identifier 210A and the vehicle 20 identified by the second vehicle identifier 210B, the parking management system 100 withdraws the barrier 38 to grant the vehicle 20 passage to exit the parking facility 30 and processes and completes the parking session 250. Optionally, the parking manager 200 may require the user 12 to submit payment for all parking sessions 250 associated with the vehicle 20 before withdrawing the barrier 38. Similarly, if the parking manager 200 determines, based on a timestamp of when the vehicle 20 entered the parking facility 30 and a timestamp associated with the image data captured at the exit 38, that the parking session 250 has exceeded the duration of a prepayment, the parking management system 100 may request from the user 12, via the kiosk 112, a remaining balance before withdrawing the barrier 38. In some examples, the parking manager 200 may not receive, from the user device 10, the parking request 220 for the vehicle 20. For example, the user 12 may forget to transmit the parking request 220. Alternatively, the user device 10 may fail to transmit and/or the remote system 140 may fail to receive the parking request 220. That is, in some examples, the vehicle 20 enters the parking facility 30 and attempts to then leave the parking facility 30 without the user 12 ever successfully submitting a parking request 220. In these examples, the parking manager 200 may determine that the vehicle 20 identified by the first vehicle identifier 210A matches or is the same as the vehicle 20 identified by the vehicle identifier 210 derived from image data captured by image sensor 108 (which would be the second vehicle identifier 210B since a second vehicle identifier 210B was not previously received from the user device 10), and that the vehicle 20 does not have an associated parking request 220 requesting a parking session 250 (i.e., the vehicle 20 does not have an associated parking session 250). The parking manager 200 may still determine a fee associated with the vehicle 20 based on the timestamp associated with the first vehicle identifier 210A.

Based on determining that the vehicle 20 does not have an associated parking session 250 the parking management system 100 may request, from a driver of the vehicle 20 that does not have an associated parking session 250, a payment method to pay the parking fee. For example, the parking management system 100 may include a kiosk 112 (discussed further below) located at or near the exit 40 of the parking facility 30. The parking management system 100 may, via the kiosk 112, request the payment method to pay the parking fee. Based on receiving, via the kiosk 112, the payment method, the parking management system 100 may withdraw the barrier 38 to grant the vehicle 20 passage to exit the parking facility 30 and process the payment.

In other examples, the image sensor 108, the parking manager 200, and/or the third-party server may fail to derive and/or extract the third vehicle identifier 210C from the image data captured by the image sensor 108. For example, an object, a person, another vehicle, or glare may obscure the vehicle 20 from view of the image sensor 108. The parking management system 100 may determine that the image data captured by the image sensor 108 does not contain a vehicle identifier 210 that matches the vehicle 20 identified by the first vehicle identifier 210A or the vehicle 20 identified by the second vehicle identifier 210B (the vehicle identifier 210 received from the user device 10). That is, the parking manager 200 may not recognize the vehicle 20 at the exit 40 of the parking facility 30 based on being unable to successfully capture a vehicle identifier 210 (e.g., the license plate).

In one example, based on determining that the image data captured by the image sensor 108 does not contain a vehicle identifier 210 that matches the vehicle 20 identified by the first vehicle identifier 210A or the vehicle 20 identified by the second vehicle identifier 210B, the parking management system 100 may request, from a driver of the vehicle 20, for a vehicle identifier 210 (e.g., a license plate number) or a time at which the vehicle 20 entered the parking facility 30. The parking manager 200 may, via the kiosk 112, request the vehicle identifier or the time at which the vehicle 20 entered the parking facility 30. The parking manager 200 may receive, via the kiosk 112, and from the driver of the vehicle 20, the vehicle identifier 210 and/or the time at which the vehicle 20 entered the parking facility 30. Additionally or alternatively, the parking manager 200 may determine, based on receiving the time at which the vehicle 20 entered the parking facility 30, a timestamp associated with the image data and/or the first vehicle identifier 210A matches the time received from the driver. The parking manager 200 may determine, based on the timestamp matching the time received from the driver, that the vehicle 20 identified by the first vehicle identifier 210A and the vehicle 20 identified by the second vehicle identifier 210B matches the vehicle 20 at the barrier 38. Based on receiving, from the driver, the vehicle identifier 210 or the time at which the vehicle 20 entered the parking facility 30, the parking manager 200 may withdraw the barrier 38 to grant the vehicle 20 passage to exit the parking facility 30 and process and complete the parking session 250.

In another example, based on determining that the image data captured by the image sensor 108 does not contain a vehicle identifier 210 that matches the vehicle 20 identified by the first vehicle identifier 210A or the vehicle 20 identified by the second vehicle identifier 210B, the parking manager 200 may present the driver, via the kiosk 112, parking sessions 250 that have not been completed. The driver may then, via the kiosk 112, select the parking session 250 associated with the vehicle 20. Alternatively, the parking management system 100 may present to the driver, via kiosk 112, vehicle identifiers 210 of vehicles that previously entered the parking facility 30 but are not yet associated with a parking session. The driver may then select the vehicle 20 from the vehicle identifiers presented to the driver. The parking management system 100 may then receive, via the kiosk 112, the selection of the driver. Based on receiving the selection from the driver, the parking management system 100 may withdraw the barrier 38 to grant the vehicle 20 passage to exit the parking facility 30 and process and complete the parking session 250.

In some examples, the parking management system 100 may include a local data storage device 116. For example, the local data storage device 116 may be located at the kiosk 112. Additionally or alternatively, the local data storage device 116, or a second local data storage device, may be located at the entrance kiosk 114. The parking management system 100 may store parking sessions 250 and/or vehicle identifiers 210 at the local data storage device 116. For example, the parking management system 100 may store parking sessions 250 that have not been completed and/or of vehicles that previously entered the parking facility 30 but are not yet associated with a parking session 250. The parking management system 100 may periodically, via an Internet connection, synchronize the data stored at the local data storage device 100 with remote aspects of the parking management system 100, such as a remote server or the parking manager 200 if located remotely from the parking facility 30.

Accordingly, if the parking manager 200 has no Internet connection with the other aspects of the parking management system 100 when the vehicle 20 arrives at the exit 40, the parking management system 100 may determine whether the image data captured by the image sensor 108 contains a vehicle identifier 210 that matches vehicle identifiers 210 of a vehicle 20 associated with the vehicle identifiers 210 and/or parking sessions 250 stored at the local data storage device 116. Thus, in examples where the parking manager 200 is not local to the parking facility 30, the parking management system 100 can continue to process parking sessions 250 for vehicles during an internet disconnection between the parking management system 100 and the parking manager 200.

Accordingly, if the parking manager 200 has no Internet connection with the other aspects of the parking management system 100 when the vehicle 20 arrives at the exit 40, the parking management system 100 may store the image data captured by the image sensor 108 at the local data storage device 116 and withdraw the barrier 38 to grant the vehicle 20 passage to exit the parking facility 30. When the Internet connection between the parking manager 200 and the other aspects of the parking management system 100 restores, the parking manager 200 may derive, from the image data stored local data storage device 116, a vehicle identifier 210 that matches vehicle identifiers 210 of the vehicle 20 and complete the parking session 250. Thus, in examples where the parking manager 200 is not local at the parking facility 30, the parking management system 100 can store image data and/or other data with which to later process parking sessions 250 for vehicles that exit the parking facility 30 during internet disconnections.

If the parking management system 100 receives a credit card payment during a period of Internet disconnection, the credit card information may be stored at the local data storage device 116 until the internet is restored and the credit card transaction can be processed. Any data captured, collected, or otherwise received at aspects of the parking management system 100 local to the parking facility 30 may be stored at the local data storage device 116 for later communication to a remote system and/or device, including image data, vehicle identifiers 210, parking sessions 250, phone numbers associated with user devices 10, confirmation codes (discussed below), payment information, etc.

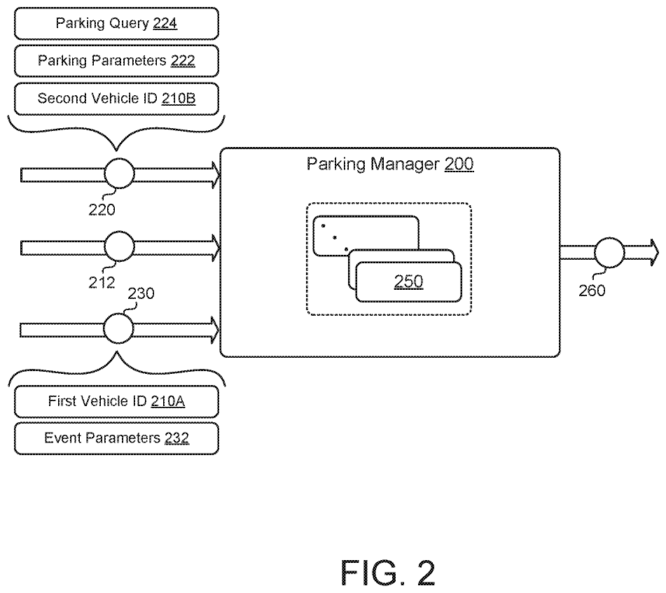

Referring now to FIG. 2, in some implementations, the parking manager 200 receives the first vehicle identifier 210A within a vehicle event message 230. The vehicle event message includes information derived from image data captured by the image sensor 102 (e.g., the first vehicle identifier 210A) and other event parameters 232 such as a location of the image sensor 102 and/or the vehicle 20, a timestamp of when the vehicle 20 entered the parking facility 30 or when the image data was captured, other identifying characteristics of the vehicle 20, a location of the parking facility 30, the phone number associated with the user device 10, etc. The event parameters 232 may be associated with the corresponding parking session 250 that is generated after receiving the parking request 220.

The parking request 220 includes the second vehicle identifier 210B and, optionally, one or more parking parameters 222. The parking parameters 222 may include details such as a parking rate, a specific parking product, a parking duration, a promotional code, user details (e.g., name, contact information, user credentials, payment information, phone number, etc.), and the like. The parking manager 200 may generate the parking session 250 based in part on the parking parameters 222. The parking parameters 222 may at least in part be supplied by the user 12 via the same interface the user 12 provides the second vehicle identifier 210B (e.g., a form or other user-selectable interface provided by a graphical user interface (GUI) executing on the user device 10).

Optionally, upon receiving payment information, the parking manager 200 may verify that the payment information is valid before generating the parking session 250. For example, the parking manager 200 may determine that a credit card provided by the user 12 is valid (i.e., not expired or declined). Additionally or alternatively, the parking manager 200 may verify a promotional code (e.g., a coupon, discount, parking validation, etc.) is valid. Based on determining that the payment information is not valid, the parking manager 200 may request a new payment method before generating the parking session 250.

The parking manager 200 generates and maintains a parking session 250 for each independent vehicle 20 located within the parking facility 30. Upon receipt of the third vehicle identifier 210C indicating that a corresponding vehicle 20 is at the exit 40 of the parking facility 30, the parking manager 200 completes the parking session 250. For example, the parking facility 30 completes payment for the parking session 250 based on the parking parameters 222, the event parameters 232, and any other relevant information. For example, the parking manager 200 receives the third vehicle identifier 210C via an event message 230 that includes a timestamp indicating when the vehicle 20 is at the exit 40 of the parking facility 30. Based on the timestamp of the first event message 230 when the vehicle 20 entered the parking facility 30 and the timestamp of the second event message 230 when the vehicle 20 is at the exit 40 of the parking facility 30, the parking manager 200 may determine a parking duration and charge for the parking session 250 accordingly.

The parking manager 200 may, upon receipt of the third vehicle identifier 210C indicating that a corresponding vehicle 20 is at the exit 40, verify whether the payment information associated with the parking session 250 is valid. In some examples, the parking manager 200 may determine that the payment information is valid. For example, when a user 12 provides a credit card as the payment method, the parking manager 200 may determine or verify that the credit card is still valid (i.e., not expired, declined, etc.). Based on determining that the vehicle 20 identified by the third vehicle identifier 210C matches or is the same as the second vehicle 20 identified by the first vehicle identifier 210A and the vehicle 20 identified by the second vehicle identifier 210B, and determining that the payment information is valid, the parking management system 100 withdraws the barrier 38 to grant the vehicle 20 passage to exit the parking facility 30 and completing the parking session 250.

In other examples, the parking manager 200 may determine that the payment information is invalid. For example, the parking manager 200 may determine that the credit card is expired or declined. Based on determining that the payment information is invalid, the parking manager 200 may request, from a driver of the vehicle 20 via the kiosk 112, an alternative payment. The parking management system 100 may receive, from the driver, the alternative payment. The alternative payment may be, for example, a credit card, a debit card, legal tender, a promotional code and/or coupon (e.g., a discount code, parking validation, etc.), and/or any combination of payment methods. Based on determining that the vehicle 20 identified by the third vehicle identifier 210C matches or is the same as the vehicle 20 identified by the first vehicle identifier 210A and the vehicle 20 identified by the second vehicle identifier 210B and receiving the alternative payment, the parking management system 100 withdraws the barrier 38 to grant the vehicle 20 passage to exit the parking facility 30 and completing the parking session 250.

In some implementations, the parking request 220 includes a parking query 224. The parking query 224 includes a portion of the first vehicle identifier 210A. For example, the user 12 may begin entering or providing the second vehicle identifier 210B (e.g., begins reciting the license plate number 22 of the vehicle 20). The parking manager 200, in response, may perform a wildcard smart search and return to the user 12 the first vehicle identifier 210A. For example, the parking manager 200 returns all vehicle identifiers 210 that represent vehicles 20 currently located within the parking facility 30 and include an associated vehicle identifier 210 portion that matches the portion provided by the user 12. Optionally, the parking manager 200 may return all vehicle identifiers 210 collected by the parking facility monitor 104. The user 12 may then select, from the provided vehicle identifiers 210, the vehicle identifier 210 that matches the user's vehicle 20. For example, the parking manager 200, via the user device 10, displays multiple vehicle identifiers 210 that potentially match the vehicle identifier 210 of the user's vehicle 20, and the user 12 selects the appropriate vehicle identifier 210.

In some examples, the parking request 220 includes location information representative of a location of the user device 10 and/or the vehicle 20. In response, the parking manager 200 transmits, to the user device 10, parking facility identification information identifying the parking facility 30 based on the location information. For example, the user device 10, using a GPS sensor of the user device 10, transmits the approximate location of the user device 10 to the parking manager 200. The parking manager 200, based on the location of the user device 10, determines which parking facility 30 the vehicle 20 is located within. The parking manager 200 provides the parking facility identification information to the user 12 to facilitate generation of the parking request 220 and/or the parking session 250.

Optionally, the parking manager 200 generates one or more notifications 260 for the user device 10. For example, upon generation and/or completion of a corresponding parking session 250, the parking manager 200 provides a notification 260 to the user device 10 (e.g., based on contact information provided via the parking request 220). The notification 260 may include any relevant information, such as parking facility 30 information, vehicle location, estimated parking costs, actual parking costs, security alerts, etc. Additionally or alternatively, the parking manager 200 provides a confirmation code to the user device 10 for the parking session 250. For example, the parking manager 200, based on receiving the parking request 220 and determining the vehicle 20 identified by the first vehicle identifier 210A, the parking manager 200 may generate a parking session 250 for the vehicle 20 that includes a confirmation code for the parking session 250. The parking manager 200 may communicate the confirmation code to the user device 10.

Each confirmation code uniquely identifies each parking session 250. Accordingly, the confirmation code may be used to help identify a vehicle 20 at the exit 40 of the parking facility 30. For example, the parking manager 200 may receive a third vehicle identifier 210C identifying the vehicle 20 at barrier 38 located at the exit 40 of the parking facility 30. The parking manager 200 may determine that the vehicle 20 identified by the third vehicle identifier 210C fails to match or is not the same as the vehicle 20 identified by the first vehicle identifier 210A and the vehicle 20 identified by the second vehicle identifier 210B. Based on determining that the vehicle 20 identified by the third vehicle identifier 210C fails to match as the vehicle 20 identified by the first vehicle identifier 210A and the vehicle 20 identified by the second vehicle identifier 210B, the parking manager 200 may request, from a driver of the vehicle 20 via the kiosk 112 or the user device 10, the confirmation code. The parking manager 200 may receive, from the driver of the vehicle 20 via the kiosk 112 or the user device 10, the confirmation code. The parking management system 100 may withdraw, based on receiving the confirmation code, the barrier 38 to grant the vehicle 20 passage to exit the parking facility 30 and complete the parking session 250. In other examples, based on determining that the vehicle 20 identified by the third vehicle identifier 210C fails to match as the vehicle 20 identified by the first vehicle identifier 210A and the vehicle 20 identified by the second vehicle identifier 210B, the parking manager 200 may request, from a driver of the vehicle 20 via the kiosk 112 or the user device 10, the phone number associated with the parking session 250.

In some implementations, the user 12 reserves a parking location 32 by transmitting the parking request 220 arriving at the parking facility 30. In this scenario, the parking manager 200 matches the second vehicle identifier 210B from the parking request to the first vehicle identifier 210A after the vehicle 20 enters the parking facility 30 to generate the appropriate parking session 250.

Thus, the parking manager 200 provides automated, ticketless parking management for user 12 using a parking facility 30 for parking facilities with or without attendants. The parking manager 200 identifies vehicles 20 entering and exiting the parking facility 30 (e.g., at a gated entrance and/or exit) via an image sensor capturing image data representative of a first vehicle identifier 210A of the vehicle 20. Transient users 12 (i.e., users that do not have a subscription to the parking facility, such as a monthly parking pass) may generate a parking session 250 by sending the parking manager 200 a second vehicle identifier 210B that matches the first vehicle identifier 210A. Subscription-based users may generate a parking session 250 automatically by entering the parking facility 30 without the need to provide the second vehicle identifier 210B, as the parking manager 200 may store vehicle identifiers 210 of all authorized users 12. The parking manager 200 may automatically complete a parking session 250 when receiving a third vehicle identifier 210C indicating that the vehicle 20 is at the exit 40 of the parking facility 30.

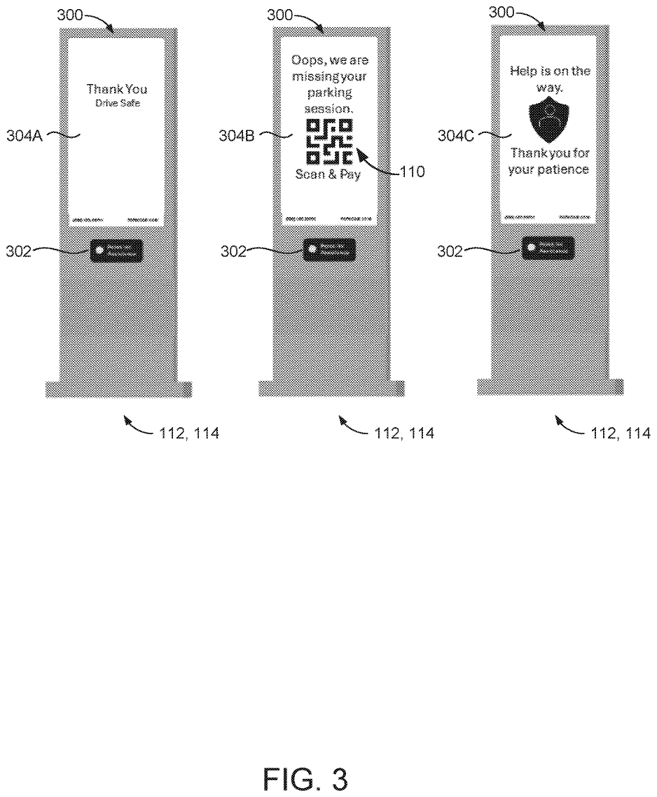

Referring now to FIG. 3, in some implementations, the parking management system 100 may include one or more kiosks 112, 114 located at or near the entrance 34 and/or exit 40 of the parking facility 30. The kiosk 112, 114 may include a monitor 300 (e.g., an LCD screen, an LED screen, a touchscreen, etc.). The kiosk 112, 114 may also include a button 302, which a user 12 or a driver may press in order to request assistance from an attendant if the user 12 needs help with payment, completing a parking session 250, or establishing a parking session 250. The monitor 300 may display an image 304A-C (e.g., a graphic, an animation, a menu, etc.) based on determinations of the parking manager 200.

With the button 302, the user 12 or the driver of the vehicle 20 may request assistance from an attendant. Upon receiving the request, the parking management system 100 may communicate a notification to the attendant that the user 12 (or a driver of the vehicle 20) has requested assistance. The notification may be communicated to a mobile device (e.g., a phone, a tablet, etc.), a computer, a radio communication device, a pager, and/or another means. The notification may include a number associated with the kiosk 112, 114 at which the user 12 made the request, a confirmation code provided by the user 12 at the kiosk 112, 114, and/or a vehicle identifier 210 identifying the vehicle 20. The attendant may assist the user 12 with tendering payment, determining the parking session 250 associated with the vehicle 20, or creating a parking session 250 if the user did not submit a parking request 220. The assistant may physically travel to the location of the kiosk 112. Alternatively, the assistant may virtually assist the user 12 via electronic communication between the kiosk 112, 114 and the assistant. For example, the kiosk 112, 114 may use a camera, speaker, and/or microphone to allow the user and assistant to communicate.

Referring to the kiosk 112 at the exit 40 of the parking facility 30, in one example, based on determining that the vehicle 20 identified by the third vehicle identifier 210C is the same as the second vehicle 20 identified by the first vehicle identifier 210A and the vehicle 20 identified by the second vehicle identifier 210B, and determining that the payment information is valid, the parking management system 100 may display image 304A at the kiosk 112, indicating that the parking session 250 is complete. For example, the kiosk 112 may display an image 304A thanking the user 12 for using the parking facility 30.

In another example, the parking manager 200 may determine that the parking session 250 associated with the vehicle 20 at the exit 40 cannot be completed. For example, the parking manager 200 may determine that the vehicle 20 is not associated with a parking session 250, that it has not received a third vehicle identifier 210C that matches other vehicle identifiers 210 of vehicles 20 located within the parking facility 30, or that the payment method associated with the parking session 250 of the vehicle 20 is invalid. Accordingly, the parking management system 100 may display image 304B at the kiosk 112, indicating that the parking session 250 cannot be completed.

Optionally, the image 304B may include the QR code 110. The user 12 or a driver may scan the QR code 110 with the user device 10 or another device. The QR code 110 may direct the user 12 or the driver to execute the proper application, where the user 12 may provide a payment method, submit a parking request 220, or otherwise identify the vehicle. Optionally, the QR code 110 may direct the user device 10 to execute an application or a specific URL, at which the user 12 may begin entering or providing the second vehicle identifier 210B (e.g., begins reciting the license plate number 22 of the vehicle 20). The parking manager 200, in response, may perform a wildcard smart search and return to the user 12 the first vehicle identifier 210A and/or the third vehicle identifier 210C. Additionally or alternatively, the parking manager 200 may return all vehicle identifiers 210 collected by the parking facility monitor 104. The user 12 may then select, from the provided vehicle identifiers 210, the vehicle identifier 210 that matches the second vehicle identifier 210B of the user's vehicle 20. Based on the user 12 selecting the second vehicle identifier 210B, the parking management system 100 may complete the parking session 250 and withdraw the barrier 38.

In a further example, the user 12 may press the button 302 in order to request assistance from the attendant. Accordingly, the parking management system 100 may display image 404C at the kiosk 112, 114 indicating that the parking attendant is notified of the request.

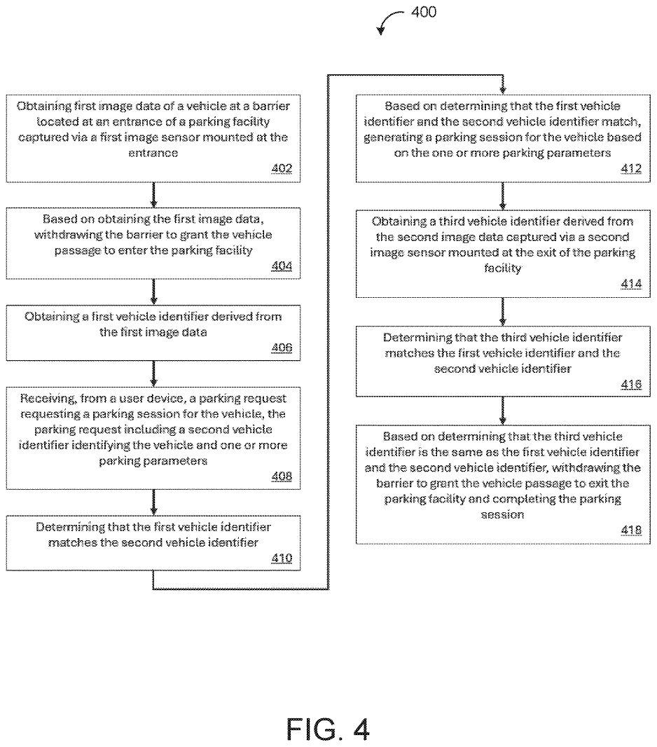

FIG. 4 is a flowchart of an exemplary arrangement of operations for a method 400 for an automated, ticketless parking management system. The method 400 includes, at operation 402, obtaining first image data of a vehicle 20 at a barrier 36 (e.g., a gate, spike strips, etc.) located at an entrance 34 of a parking facility 30. The first image data is captured via a first image sensor 102 (e.g., a camera or the like) mounted at or near the entrance 34. At operation 404, based on obtaining the first image data, the barrier 36 is withdrawn to grant the vehicle 20 passage to enter the parking facility 30. At operation 406, a first vehicle identifier 210A identifying the vehicle 20 entering a parking facility 30 is received. The first vehicle identifier 210A is derived from the first image data captured via the first image sensor 102. At operation 408, the method 400 includes receiving, from a user device 10, a parking request 220 requesting a parking session for the vehicle 20 at the parking facility 30. The parking request 220 includes a second vehicle identifier 210B identifying the vehicle 20 and one or more parking parameters 222. The method 400, at operation 410, includes determining that the first vehicle identifier 210A matches the second vehicle identifier 210B. At operation 412, the method 400 includes, based on determining that the first vehicle identifier 210A and the second vehicle identifier 210B match, generating a parking session 250 for the vehicle 20 based on the one or more parking parameters 222. The method 400, at operation 414, includes obtaining a third vehicle identifier 210C identifying the vehicle 20 at the exit 40 of the parking facility 30. The third vehicle identifier 210C is derived from image data captured via a second image sensor 102 mounted at or near the exit 40 of the parking facility 30. At operation 416, the method 400 includes determining that the third vehicle identifier 210C matches the first vehicle identifier 210A and the second vehicle identifier 210B. Based on determining that the third vehicle identifier 210C matches the first vehicle identifier 210A and the second vehicle identifier 210B, the method 400, at operation 418, includes withdrawing the barrier 38 to grant the vehicle 20 passage to exit the parking facility 30 and completing the parking session 250.

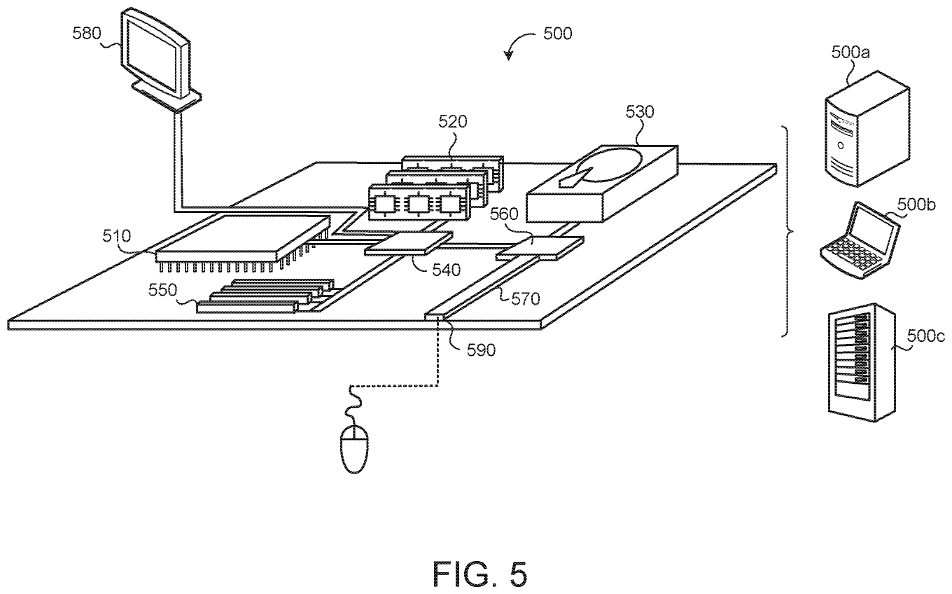

FIG. 5 is a schematic view of an example computing device 500 that may be used to implement the systems and methods described in this document. The computing device 500 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 500 includes a processor 510, memory 520, a storage device 530, a high-speed interface/controller 540 connecting to the memory 520 and high-speed expansion ports 550, and a low speed interface/controller 560 connecting to a low speed bus 570 and a storage device 530. Each of the components 510, 520, 530, 540, 550, and 560, are interconnected using various busses, and may be mounted on a common motherboard or in other manners as appropriate. The processor 510 can process instructions for execution within the computing device 500, including instructions stored in the memory 520 or on the storage device 530 to display graphical information for a graphical user interface (GUI) on an external input/output device, such as display 580 coupled to high speed interface 540. In other implementations, multiple processors and/or multiple buses may be used, as appropriate, along with multiple memories and types of memory.

Also, multiple computing devices 500 may be connected, with each device providing portions of the necessary operations (e.g., as a server bank, a group of blade servers, or a multi-processor system).

The memory 520 stores information non-transitorily within the computing device 500. The memory 520 may be a computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage device 530 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer-or machine-readable medium, such as the memory 520, the storage device 530, or memory on processor 510.

The high speed controller 540 manages bandwidth-intensive operations for the computing device 500, while the low speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port 590. The low-speed expansion port 590, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

1. A computer-implemented method executed by data processing hardware that causes the data processing hardware to perform operations comprising:
obtaining first image data of a vehicle at a first barrier located at an entrance of a parking facility, the first image data captured via a first image sensor mounted at the entrance of the parking facility;
after obtaining the first image data, withdrawing the first barrier to grant the vehicle passage to enter to the parking facility;
obtaining a first vehicle identifier identifying the vehicle, the first vehicle identifier derived from the first image data;
receiving, from a user device, a parking request requesting a parking session for the vehicle at the parking facility, the parking request comprising:
a second vehicle identifier identifying the vehicle; and
one or more parking parameters;
determining that the first vehicle identifier matches the second vehicle identifier;
based on determining that the vehicle identified by the first vehicle identifier and the vehicle identified by the second vehicle identifier match, generating the parking session for the vehicle based on the one or more parking parameters;
obtaining a third vehicle identifier identifying the vehicle at a second barrier located at an exit of the parking facility, the third vehicle identifier derived from second image data captured via a second image sensor mounted at the exit of the parking facility;
determining that the third vehicle identifier matches the first vehicle identifier and the second vehicle identifier; and
based on determining that the third vehicle identifier matches the first vehicle identifier and the second vehicle identifier, withdrawing the second barrier to grant the vehicle passage to exit the parking facility and completing the parking session.

2. The method of claim 1, wherein the first vehicle identifier comprises an alphanumeric identifier of a license plate of the vehicle.

3. The method of claim 1, wherein the first vehicle identifier, the second vehicle identifier, and the third vehicle identifier comprise a visual feature of the vehicle.

4. The method of claim 1, further comprising:
obtaining third image data of a second vehicle at the first barrier;
after obtaining the third image data, withdrawing the first barrier to grant the second vehicle passage to enter to the parking facility;
determining that a vehicle identifier cannot be derived from the third image data;
obtaining fourth image data of the second vehicle while the second vehicle is within the parking facility, the fourth image data captured via a parking facility monitor,
obtaining a fourth vehicle identifier identifying the second vehicle, the fourth vehicle identifier derived from the fourth image data;
receiving, from a second user device, a second parking request requesting a second parking session for the second vehicle at the parking facility, the second parking request comprising:
a fifth vehicle identifier identifying the second vehicle; and
one or more second parking parameters;
determining that the fourth vehicle identifier matches the fifth vehicle identifier;
based on determining that fourth vehicle identifier and the fifth vehicle identifier match, generating the second parking session for the second vehicle based on the one or more second parking parameters;
obtaining a sixth vehicle identifier identifying the second vehicle at the second barrier located at the exit of the parking facility, the sixth vehicle identifier derived from fifth image data captured via the second image sensor mounted at the exit of the parking facility;
determining that the sixth vehicle identifier matches the fourth vehicle identifier and the fifth vehicle identifier; and
based on determining that the sixth vehicle identifier matches the fourth vehicle identifier and the fifth vehicle identifier, withdrawing the second barrier to grant the second vehicle passage to exit the parking facility and completing the parking session.

5. The method of claim 4, wherein the parking facility monitor comprises a mobile parking facility monitor.

6. The method of claim 1, further comprising:
obtaining third image data of a second vehicle at the first barrier;
after obtaining the third image data, withdrawing the first barrier to grant the second vehicle passage to enter to the parking facility;
obtaining a fourth vehicle identifier identifying the second vehicle, the fourth vehicle identifier derived from the third image data;
receiving, from a second user device, a second parking request requesting a second parking session for the second vehicle at the parking facility, the second parking request comprising:
a fifth vehicle identifier identifying the second vehicle; and
one or more second parking parameters;
determining that the fourth vehicle identifier fails to match the fifth vehicle identifier;
based on determining that the fourth vehicle identifier and the fifth vehicle identifier do not match, requesting, from a user of the second user device, a sixth vehicle identifier identifying the second vehicle;
receiving, from the user, the sixth vehicle identifier;
obtaining a seventh vehicle identifier identifying the second vehicle, the seventh vehicle identifier derived from the third image data, the seventh vehicle identifier different from the fourth vehicle identifier;
determining that the sixth vehicle identifier matches the seventh vehicle identifier;
based on determining that the sixth vehicle identifier and the seventh vehicle identifier match, generating the parking session for the second vehicle based on the one or more second parking parameters;
obtaining an eighth vehicle identifier identifying the second vehicle at the second barrier located at the exit of the parking facility, the eighth vehicle identifier derived from fourth image data captured via the second image sensor mounted at the exit of the parking facility;
determining that the eighth vehicle identifier matches at least one of the fourth vehicle identifier, the fifth vehicle identifier, the sixth vehicle identifier, or the seventh vehicle identifier; and
based on determining that the eighth vehicle identifier matches at least one of the fourth vehicle identifier, the fifth vehicle identifier, the sixth vehicle identifier, or the seventh vehicle identifier, withdrawing the second barrier to grant the second vehicle passage to exit the parking facility and completing the parking session.

7. The method of claim 6, wherein the fifth vehicle identifier comprises an alphanumeric identifier of a license plate, and wherein the sixth vehicle identifier comprises at least one of a make of the second vehicle, a model of the second vehicle, or a color of the second vehicle.

8. The method of claim 1, further comprising:
obtaining third image data of a second vehicle at the first barrier located at the entrance of the parking facility, the third image data captured via the first image sensor mounted at the entrance of the parking facility;
after obtaining the third image data, withdrawing the first barrier to grant the second vehicle passage to enter to the parking facility;
obtaining a fourth vehicle identifier identifying the second vehicle, the fourth vehicle identifier derived from the third image data;
obtaining a fifth vehicle identifier identifying the second vehicle at the second barrier located at the exit of the parking facility, the fifth vehicle identifier derived from fourth image data captured via the second image sensor mounted at the exit of the parking facility;
determining that the fifth vehicle identifier matches the fourth vehicle identifier;
after determining that the fifth vehicle identifier matches the fourth vehicle identifier, determining that the second vehicle is not associated with an active parking session;
based on determining that the second vehicle is not associated with an active parking session, requesting, from a driver of the second vehicle, a payment method;
receiving, from the driver of the second vehicle, the payment method; and
based on receiving the payment method, withdrawing the second barrier to grant the second vehicle passage to exit the parking facility and completing the parking session.

9. The method of claim 1, further comprising:
obtaining third image data of a second vehicle at the first barrier located at the entrance of the parking facility, the third image data captured via the first image sensor mounted at the entrance of the parking facility;
after obtaining the third image data, withdrawing the first barrier to grant the second vehicle passage to enter to the parking facility;
obtaining a fourth vehicle identifier identifying the second vehicle, the fourth vehicle identifier derived from the third image data;
receiving, from a second user device, a second parking request requesting a second parking session for the second vehicle at the parking facility, the second parking request comprising:
a fifth vehicle identifier identifying the second vehicle; and
one or more second parking parameters;
determining that the fourth vehicle identifier matches the fifth vehicle identifier;
based on determining that the fourth vehicle identifier and the fifth vehicle identifier match, generating the second parking session for the second vehicle based on the one or more second parking parameters;
obtaining fourth image data of the second vehicle at the second barrier located at the exit of the parking facility, the fourth image data captured via the second image sensor mounted at the exit of the parking facility;
determining that a vehicle identifier cannot be derived from the fourth image data;
based on determining that a vehicle identifier cannot be derived from the fourth image data, requesting, from a driver of the second vehicle, a sixth vehicle identifier;
receiving, from the driver, the sixth vehicle identifier;
determining that the sixth vehicle identifier matches the fourth vehicle identifier and the fifth vehicle identifier; and
based on determining that the sixth vehicle identifier matches the fourth vehicle identifier and the fifth vehicle identifier, withdrawing the barrier of the exit and completing the parking session.

10. The method of claim 1, further comprising, prior to withdrawing the second barrier, determining that payment information associated with the parking session is valid, wherein withdrawing the second barrier is further based on determining that the payment information associated with the parking session is valid.

11. The method of claim 1, further comprising:
determining that payment information associated with the parking session is invalid;
based on determining that the payment information is invalid, requesting, from a driver of the vehicle, an alternative payment; and
receiving the alternative payment,
wherein withdrawing the second barrier is further based on receiving the alternative payment.

12. The method of claim 1, further comprising:
obtaining third image data of a second vehicle at the first barrier located at the entrance of the parking facility, the third image data captured via the first image sensor mounted at the entrance of the parking facility;
after obtaining the third image data, withdrawing the first barrier to grant the second vehicle passage to enter to the parking facility;
obtaining a fourth vehicle identifier identifying the second vehicle, the fourth vehicle identifier derived from the third image data;
receiving, from a second user device, a second parking request requesting a second parking session for the second vehicle at the parking facility, the second parking request comprising:
a fifth vehicle identifier identifying the second vehicle; and
one or more second parking parameters;
determining that the fourth vehicle identifier matches the fifth vehicle identifier;
based on determining that the fourth vehicle identifier and the fifth vehicle identifier match, generating the second parking session for the second vehicle based on the one or more second parking parameters, the second parking session comprising a confirmation code;
obtaining a sixth vehicle identifier identifying the second vehicle at the second barrier located at the exit of the parking facility, the sixth vehicle identifier derived from fifth image data captured via the second image sensor mounted at the exit of the parking facility;
determining that the sixth vehicle identifier fails to match the fourth vehicle identifier and the fifth vehicle identifier;
based on determining that the sixth vehicle identifier fails to match the fourth vehicle identifier and the fifth vehicle identifier, requesting, from a driver of the second vehicle, the confirmation code;
receiving, from the driver of the second vehicle, the confirmation code; and
based on receiving the confirmation code, withdrawing the second barrier to grant the vehicle passage to exit the parking facility and completing the parking session.

13. A system comprising:
data processing hardware; and
memory hardware in communication with the data processing hardware, the memory hardware storing instructions that when executed on the data processing hardware cause the data processing hardware to perform operations comprising:
obtaining first image data of a vehicle at a first barrier located at an entrance of a parking facility, the first image data captured via a first image sensor mounted at the entrance of the parking facility;
after obtaining the first image data, withdrawing the first barrier to grant the vehicle passage to enter to the parking facility;
obtaining a first vehicle identifier identifying the vehicle, the first vehicle identifier derived from the first image data;
receiving, from a user device, a parking request requesting a parking session for the vehicle at the parking facility, the parking request comprising:
a second vehicle identifier identifying the vehicle; and
one or more parking parameters;
determining that the first vehicle identifier matches the second vehicle identifier;
based on determining that the vehicle identified by the first vehicle identifier and the vehicle identified by the second vehicle identifier match, generating the parking session for the vehicle based on the one or more parking parameters;
obtaining a third vehicle identifier identifying the vehicle at a second barrier located at an exit of the parking facility, the third vehicle identifier derived from second image data captured via a second image sensor mounted at the exit of the parking facility;
determining that the third vehicle identifier matches the first vehicle identifier and the second vehicle identifier; and
based on determining that the third vehicle identifier matches the first vehicle identifier and the second vehicle identifier, withdrawing the second barrier to grant the vehicle passage to exit the parking facility and completing the parking session.

14. The system of claim 13, wherein the first vehicle identifier comprises an alphanumeric identifier of a license plate of the vehicle.

15. The system of claim 13, wherein the first vehicle identifier, the second vehicle identifier, and the third vehicle identifier comprise a visual feature of the vehicle.

16. The system of claim 13, wherein the operations further comprise:
obtaining third image data of a second vehicle at the first barrier;
after obtaining the third image data, withdrawing the first barrier to grant the second vehicle passage to enter to the parking facility;
determining that a vehicle identifier cannot be derived from the third image data;
obtaining fourth image data of the second vehicle while the second vehicle is within the parking facility, the fourth image data captured via a parking facility monitor, obtaining a fourth vehicle identifier identifying the second vehicle, the fourth vehicle identifier derived from the fourth image data;
receiving, from a second user device, a second parking request requesting a second parking session for the second vehicle at the parking facility, the second parking request comprising:
a fifth vehicle identifier identifying the second vehicle; and
one or more second parking parameters;
determining that the fourth vehicle identifier matches the fifth vehicle identifier;
based on determining that fourth vehicle identifier and the fifth vehicle identifier match, generating the second parking session for the second vehicle based on the one or more second parking parameters;
obtaining a sixth vehicle identifier identifying the second vehicle at the second barrier located at the exit of the parking facility, the sixth vehicle identifier derived from fifth image data captured via the second image sensor mounted at the exit of the parking facility;
determining that the sixth vehicle identifier matches the fourth vehicle identifier and the fifth vehicle identifier; and
based on determining that the sixth vehicle identifier matches the fourth vehicle identifier and the fifth vehicle identifier, withdrawing the second barrier to grant the second vehicle passage to exit the parking facility and completing the parking session.

17. The system of claim 16, wherein the parking facility monitor comprises a mobile parking facility monitor.

18. The system of claim 13, wherein the operations further comprise:
obtaining third image data of a second vehicle at the first barrier;
after obtaining the third image data, withdrawing the first barrier to grant the second vehicle passage to enter to the parking facility;
obtaining a fourth vehicle identifier identifying the second vehicle, the fourth vehicle identifier derived from the third image data;
receiving, from a second user device, a second parking request requesting a second parking session for the second vehicle at the parking facility, the second parking request comprising:
a fifth vehicle identifier identifying the second vehicle; and
one or more second parking parameters;
determining that the fourth vehicle identifier fails to match the fifth vehicle identifier;
based on determining that the fourth vehicle identifier and the fifth vehicle identifier do not match, requesting, from a user of the second user device, a sixth vehicle identifier identifying the second vehicle;
receiving, from the user, the sixth vehicle identifier;
obtaining a seventh vehicle identifier identifying the second vehicle, the seventh vehicle identifier derived from the third image data, the seventh vehicle identifier different from the fourth vehicle identifier;
determining that the sixth vehicle identifier matches the seventh vehicle identifier;
based on determining that the sixth vehicle identifier and the seventh vehicle identifier match, generating the parking session for the second vehicle based on the one or more second parking parameters;
obtaining an eighth vehicle identifier identifying the second vehicle at the second barrier located at the exit of the parking facility, the eighth vehicle identifier derived from fourth image data captured via the second image sensor mounted at the exit of the parking facility;
determining that the eighth vehicle identifier matches at least one of the fourth vehicle identifier, the fifth vehicle identifier, the sixth vehicle identifier, or the seventh vehicle identifier; and
based on determining that the eighth vehicle identifier matches at least one of the fourth vehicle identifier, the fifth vehicle identifier, the sixth vehicle identifier, or the seventh vehicle identifier, withdrawing the second barrier to grant the second vehicle passage to exit the parking facility and completing the parking session.

19. The system of claim 18, wherein the fifth vehicle identifier comprises an alphanumeric identifier of a license plate, and wherein the sixth vehicle identifier comprises at least one of a make of the second vehicle, a model of the second vehicle, or a color of the second vehicle.

20. The system of claim 13, wherein the operations further comprise:
obtaining third image data of a second vehicle at the first barrier located at the entrance of the parking facility, the third image data captured via the first image sensor mounted at the entrance of the parking facility;
after obtaining the third image data, withdrawing the first barrier to grant the second vehicle passage to enter to the parking facility;
obtaining a fourth vehicle identifier identifying the second vehicle, the fourth vehicle identifier derived from the third image data;
obtaining a fifth vehicle identifier identifying the second vehicle at the second barrier located at the exit of the parking facility, the fifth vehicle identifier derived from fourth image data captured via the second image sensor mounted at the exit of the parking facility;
determining that the fifth vehicle identifier matches the fourth vehicle identifier;
after determining that the fifth vehicle identifier matches the fourth vehicle identifier, determining that the second vehicle is not associated with an active parking session;
based on determining that the second vehicle is not associated with an active parking session, requesting, from a driver of the second vehicle, a payment method;
receiving, from the driver of the second vehicle, the payment method; and
based on receiving the payment method, withdrawing the second barrier to grant the second vehicle passage to exit the parking facility and completing the parking session.
